(19) United States
(12) Patent Application Publication
(10) Pub. No.: US 2014/0018968 A1
(43) Pub. Date: Jan. 16, 2014

(54) Method for determining and/or controlling an operating time of a consumer coupled to a power station, in particular a photovoltaic power station, and to an energy storage device, and method for operating an energy storage device coupled to a power station

(71) Applicant: Marcus PREISSNER, Vaihingen (DE)

(72) Inventor: Marcus PREISSNER, Vaihingen (DE)

(73) Assignee: Robert Bosch GmbH, Stuttgart (DE)

(21) Appl. No.: 13/937,632

(22) Filed: Jul. 9, 2013

(30) Foreign Application Priority Data
Jul. 13, 2012 (DE) 102012212321.0

(51) Int. Cl. G06Q 50/06

(52) U.S. Cl. CPC G06Q 50/06
USPC 700/291

(57) ABSTRACT

A device for determining an operating time of a consumer coupled to a power station and energy/storage device, having a first determining device to determine energy production from the station during a time, a second determining device to determine energy consumption of the consumer during a time, a third determining device to determine energy stored in the storage device for operating the consumer, and a prediction device to determine/display, considering the determined energy production, the determined stored energy, and the determined energy consumption, an operating time that the consumer is operatable by the energy from the station and by the stored energy, and/or having a control device to determine a consumer operating time and to adapt stored energy for operating the consumer, considering the determined energy production, the determined stored energy, and the determined energy consumption, the adaptation occurring so that the consumer is operatable for the operating time.

### RELATED APPLICATION INFORMATION

The present application claims priority to and the benefit of German patent application no. 10 2012 212 321.0, which was filed in Germany on Jul. 13, 2012, the disclosure of which is incorporated herein by reference.

### FIELD OF THE INVENTION

The present invention relates to a device for determining and/or controlling an operating time of a consumer coupled to a power station, in particular a photovoltaic power station, and to an energy storage device, and also relates to a method for operating an energy storage device coupled to a power station.

### BACKGROUND INFORMATION

Island power stations for buildings, for example photovoltaic systems, are used to produce electrical energy. The power they produce is standardly fed, to a large extent, into the public electric power grid. At present, there exist agreements relating to this according to which the operators of the photovoltaic system receive a so-called feed-in tariff or remuneration. In recent decades, this was very profitable for the operators of the photovoltaic systems, because the operator received a guaranteed feed-in remuneration for the power he produced, and the price of the power was legally regulated.

In addition, there are believed to be modern photovoltaic systems in which a portion of the power produced by the photovoltaic system is itself consumed by consumers associated with the building. Such a consumption quantity is referred to as self-consumption. The self-consumption designates the share, as a portion, of the overall quantity of electrical energy produced by the photovoltaic system that is consumed by the building-associated consumers themselves. Due to the present configuration and manner of operation of photovoltaic systems, however, this share is generally very low, and is presently no more than about 30%.

In order to increase self-consumption, in most cases an electrical energy storage device is integrated into the photovoltaic system, this device being fashioned so as to store electrical energy that is not directly used, and to draw this energy from the energy storage device at times in which the power production is lower than the power consumption, and in this way to reduce the usage of electrical power from the supply network.

In addition, photovoltaic systems make it possible to operate a consumer in autarkic fashion. In the case of total network failure, the consumer can for a certain period of time be operated autarkically as a function of the portion of the energy storage device that is provided for the autarkic operation of the consumer. This is very significant in particular in countries in which electrical supply networks are unreliable.

The determination of the portion of the energy storage device that is to be reserved for autarkic operation of the consumer is preset at the electric energy storage device, either at the factory or upon commissioning. This portion can for example be 25% of the capacity of the energy storage device. The portion of the energy storage device provided for autarkic operation is not available for self-consumption, which however reduces the cost-effectiveness of the photovoltaic system.

The greater proportion reserved for autarkic operation, the more the self-consumption rate is reduced. In the case of a portion that is selected to be too small, the stored quantity of energy is often not adequate to operate the consumer for the desired period of time.

German patent document DE 10 2009 040 090 A1 discusses an energy control device for an energy network and a method for controlling the operation of an energy controlling device. In order to supply power to a load unit connected to the energy control device in an optimized manner that meets the needs of the situation, an energy control device is provided having: an energy-producing unit, in particular a photovoltaic unit for producing energy from renewable resources, an energy storage unit for storing energy, a load terminal unit for connecting the energy control device to a load unit for the consumption of energy, a mains network connection unit, in particular an inverter unit for connecting the energy control device to an energy network in order to draw energy from the energy network and to supply energy to the energy network, and a control device for controlling an energy flow between the energy-producing unit, the energy storage unit, the load unit, and/or the energy network. A display that indicates the performance of the individual systems can be connected to the energy control device.

### SUMMARY OF THE INVENTION

The present invention provides a device for determining and/or controlling an operating time of a consumer coupled to a power station, in particular a photovoltaic power station, and to an energy storage device, having the features described herein, and provides a method for operating an energy storage device coupled to a power station, having the features described herein.

According to the present invention, the following is provided:

A device for determining and/or controlling an operating time of a consumer coupled to a power station and to an energy storage device; having a first determining device that is fashioned to determine an energy production quantity that was produced by the power station during a past time interval; having a second determining device that is fashioned to determine the energy consumption of the consumer during a past time interval; having a third determination device that is fashioned to determine the quantity of energy currently stored in the energy storage device and provided for an operation of the consumer; and having a prognostication device that is fashioned to determine and display, taking into account the determined quantity of energy production, the determined quantity of stored energy, and the determined energy consumption of the consumer, an operating time in which the consumer is capable of being operated using the quantity of energy produced by the power station and using the current quantity of energy stored in the energy storage device, and/or having a control device that is fashioned to determine an operating time of the consumer and to adapt the quantity of energy currently stored in the energy storage device, which is provided for the operation of the consumer, taking into account the determined quantity of energy production, the determined quantity of stored energy, and the determined energy consumption of the consumer, in such a way that the consumer is capable of being operated for the determined operating time.

In addition, a method is provided for operating an energy storage device coupled to a power station, in particular a photovoltaic power station, having the following method steps:
S1) determination of an energy consumption of a consumer coupled to the energy storage device during a past time interval;
S2) determination of an energy production quantity that was produced by the power station during a past time interval;
S3) determination of the quantity of energy currently stored in the energy storage device and provided for an operation of the consumer; and
S4) determination and displaying of an operating time for the consumer, taking into account the determined energy production quantity, the determined quantity of stored energy, and the determined energy consumption of the consumer; and/or
S5) determination of an operating time in which the consumer is capable of being operated using the quantity of energy produced by the power station and the quantity of energy provided in the energy storage device for the operation;
S6) adaptation of the minimum quantity of energy to be reserved in the energy storage device and provided for the operation of the consumer, taking into account the determined energy production quantity, the determined quantity of stored energy, and the determined energy consumption of the consumer, in such a way that the consumer is capable of being operated for the operating time.

Here it is provided that method steps S5) and S6) are carried out in addition or alternatively to method step S4).

An aspect of the present invention is to provide a device for determining and/or controlling an operating time of a consumer coupled to a power station and to an energy storage device, with which it is possible to display and/or set an operating time of a consumer, and at the same time to adapt the minimum charge state that is to be reserved of an energy storage device allocated to the power station, for example to a photovoltaic power station, in such a way that the operating time can be maintained. From the values determined during the past time period concerning the energy consumption of the consumer, the energy production quantity of the power station, and the current charging state of the energy storage device, the minimum charge state that is to be reserved of the energy storage device can be adapted in such a way that a determined operating time of the consumer can be maintained. The user can easily set and determine the desired operating time of the consumer.

In addition, in this way the portion can be increased that is reserved in the energy storage device for use as self-consumption. In this way, the power station can be operated more economically, reducing operating costs and increasing the profit achieved by the power station.

The portion of the capacity of the energy storage device provided for the operation of the consumer is adapted continuously or at previously determined time intervals, so that operation is ensured.

In the present connection, a consumer is to be understood as any device that consumes energy. The consumer can for example be an oven, a heating device, a television, electrical standby consumers, lighting, water heating devices, cooling and refrigeration devices, water pumps, control devices, washing machines, an industrial installation, an island system, or a combination of these energy-consuming devices. An entire building can also be regarded as a consumer.

If, for example, the first determining device has determined very high energy production quantities, the portion of the capacity provided for the operation of the consumer can be reduced, because the photovoltaic system can be expected to continue to produce a large quantity of energy.

The portion of the capacity of the energy storage device provided for the operation of the consumer can also be reduced if the second determining device has determined that the consumer has used very little energy in the past.

In the same way, the portion of the capacity of the energy storage device provided for the operation of the consumer can be increased if the determining devices determine that the consumer has used a large amount of energy and the power station has in the past produced only a small quantity of energy.

Using this method and this device, an energy storage device can be operated by a user in a very simple and convenient manner, because instead of a minimum battery capacity that is to be reserved that is preset at the factory or during installation, the target operating time for the consumer is defined, and in this way the quantity of energy provided for operation, in particular for an autarkic operation of the consumer, is adapted. By taking into account temporally variable consumption and output, the capacity reserved for operation in order to achieve the desired time duration can be reduced. In this way, self-consumption can be increased, or the battery capacity can be made smaller, both of which have a positive effect on the cost-effectiveness of the island power station.

Here, the power station is to be understood as an example of an installation that gains energy from renewable energies. Likewise, the method and the device can be adapted to cogeneration power stations, hydropower stations, wind power stations, geothermal power stations, and/or tidal power stations.

A typical operating time is determined and/or displayed in hours and days, but however can also go beyond this time period.

From the analysis of daily load histories, monthly load histories, and/or yearly load histories of the consumer, and of the daily energy production quantity, monthly energy production quantity, and/or yearly energy production quantity of the power station, for example a photovoltaic system of a building, in the past it has been possible to produce, at all times, a prediction of the energy quantity for the desired target operating time.

Advantageous specific embodiments and developments result from the subclaims and from the description, with reference to the Figures.

In a specific embodiment of the present invention, the control device is fashioned, taking into account the weather and/or the season of the year, to adapt the charge state of the energy storage device in such a way that the consumer is capable of being operated for the operating time. For this purpose, the control device obtains measurement or predictive values from weather sensors, such as air pressure, temperature, humidity, brightness, etc., that can be coupled directly to the power station, or can be sent to the control device via a network, e.g. the Internet or radio. In this way, the method and the device can adapt the charging state of the energy storage device still more precisely.

The prediction device can also obtain measurement or predictive values of the weather and/or the season, and in particular can obtain energy production prediction values and take them into account for the prediction. In this way, the prediction device can operate still more precisely.

For example, the prediction device can also be fashioned in such a way that it can indicate a probability with which the predicted operating time can be maintained. For example, the prediction device can indicate that the desired operating time can be maintained with a probability level of 95%, 80%, or 50%.

The prediction device can also be fashioned to indicate to a user the gain that has been achieved by increasing the self-consumption, or that can be expected to be achieved.

In a further specific embodiment of the present invention, the prediction device is fashioned in order to predict the time duration for different modes of operation of the consumer, in particular at maximum operation, partial operation, and minimum operation of the consumer. The consumer can for example be fashioned as an electric heating unit or air-conditioning system. The prediction device is fashioned in order to predict, taking into account the set values such as maximum operation, partial operation, and minimum operation of the electric consumer, the time in which the consumer is capable of being operated. If the consumer is operated in maximum operation, the operating time of the consumer is shortened. If the consumer is operated in minimum operation, the operating time is lengthened.

In a further specific embodiment of the present invention, a human-machine interface is coupled to the device, via which data, e.g. the set operating time or the predicted operating time, can be displayed to a user of the device. The human-machine interface can for example be fashioned as a touch-sensitive display or as a display screen having input devices coupled thereto.

In a further specific embodiment of the present invention, the device and/or the method is fashioned in order to operate the consumer in autarkic fashion for the operating time. In this context, “autarkic” means that the consumer is capable of being operated without any additional supply of energy from outside, for example via a public electric energy supply network.

In a further specific embodiment of the present invention, the energy storage device is fashioned as an electric accumulator, a compressed air storage device, a flywheel, a pump storage power station, a superconducting coil and/or a capacitor. However, other forms of energy storage devices are also possible. For example, the energy storage device can be fashioned as a lithium-ion-lithium-cobalt dioxide accumulator, lithium-polymer accumulator, lithium-manganese accumulator, lithium-iron phosphate accumulator, lithium-iron-yttrium-phosphate accumulator, lithium-titanium accumulator, lithium-sulfur accumulator, lithium-metal polymer accumulator, sodium-nickel chloride high-temperature battery, sodium-sulfur accumulator, nickel-cadmium accumulator, nickel-iron accumulator, nickel-hydrogen accumulator, nickel-metal hydride accumulator, nickel-zinc accumulator, lead accumulator, silver-zinc accumulator, vanadium-redox accumulator, and/or zinc-bromide accumulator.

The above realizations and developments can be combined with one another arbitrarily to the extent that this makes sense. Further possible embodiments, developments, and implementations of the present invention also include combinations not explicitly named of features of the present invention described above or described in the following with regard to the exemplary embodiments. In particular, the person skilled in the art will also add individual aspects to the respective basic form of the present invention, as improvements or supplements.

In the following, the present invention is explained in more detail on the basis of the exemplary embodiments indicated in the schematic Figures of the drawings.

### BRIEF DESCRIPTION OF THE DRAWINGS

FIG. 1 shows a schematic block diagram of a specific embodiment of a device for determining and/or controlling an operating time of a consumer coupled to a power station and/or to an energy storage device.

FIG. 2 shows a schematic flow diagram of a specific embodiment of a method for operating an energy storage device.

FIG. 3 shows a schematic diagram that represents the minimum quantity of energy to be reserved in the energy storage device during one year, the energy being provided for an operation of the consumer.

### DETAILED DESCRIPTION

In all the Figures, identical or functionally identical elements and devices have been provided with the same reference characters, unless otherwise indicated.

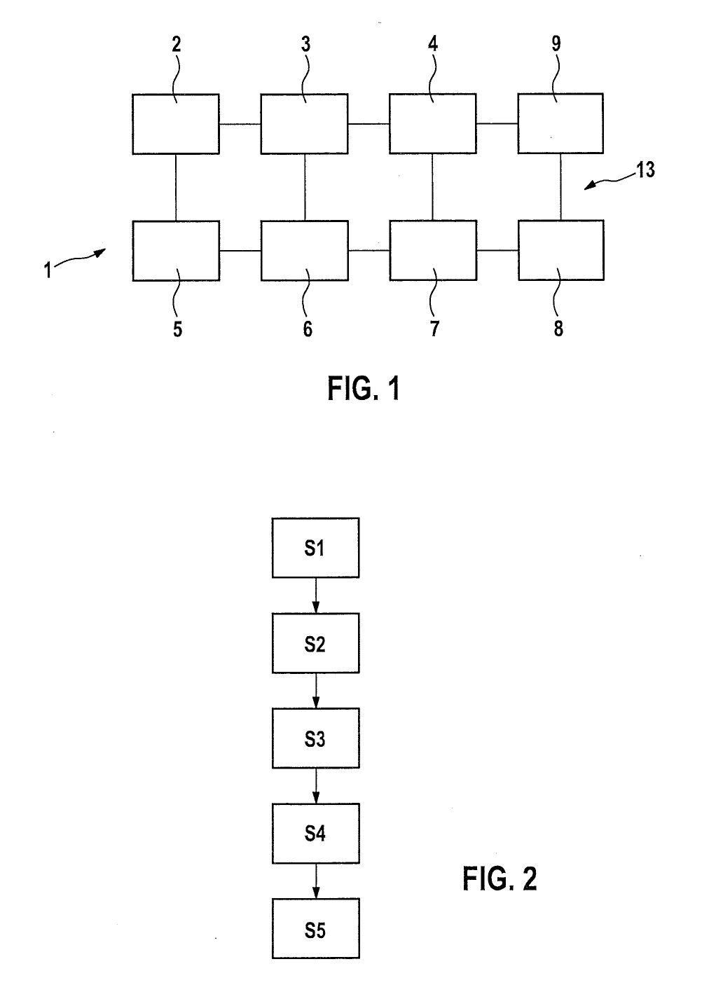

FIG. 1 shows a schematic block diagram of a specific embodiment of a device for determining and/or controlling an operating time of a consumer coupled to a power station and to an energy storage device.

Device 1 has a first determining device 3 that is fashioned to determine an energy production quantity that has been produced by power station 2, for example a photovoltaic power station, during a past time interval. For example, the first determining device has a current counter and a data storage device by which the energy production quantity can be determined and stored. In addition, device 1 has a second determining device 4 that is fashioned to determine the energy consumption of a consumer 5 during a past time interval. Second determining device 4 can also have a current counter and a data storage device that acquires and stores the electrical energy consumption of consumer 5.

In addition, a third determining device 6 is provided that is fashioned to determine the quantity of energy currently stored in an energy storage device allocated to power station 2 and provided for an operation, in particular an autarkic operation, of consumer 5.

A control device 8 is also provided that is fashioned to determine an operating time or target autarkic operating time of consumer 5. Control device 8 can for example be a touchscreen by which a user can input the desired operating time or target autarkic operating time.

In addition, according to a further specific embodiment of the present invention a reliability value can be inputted indicating the reliability with which the operating time is to be maintained. The user can for example determine that an operating time of two days is to be maintained with a reliability of 80%. In addition, it is possible to determine the operating mode of the consumer during the operating time. If, for example, the consumer is a heating unit, the user can determine that the heating unit is to be operated during the operating time with maximum output, partial output, or minimum output. This also has an effect on the quantity of energy that is to be reserved in the energy storage device for the operation, in particular for autarkic operation, of the consumer.

Control device 8 is also fashioned to adapt the quantity of energy currently stored in energy storage device 7 and provided for the operation of consumer 5, taking into account the determined energy production quantity, the determined quantity of stored energy, and the determined energy consumption of consumer 5, in such a way that consumer 5 can be operated for the operating time, in particular for the target autarkic operating time.

All system components, in particular photovoltaic system 1, first determining device 3, second determining device 4, consumer 5, third determining device 6, energy storage device 7, prediction device 9, and control device 8, are coupled to one another via a power and communication network 13.

FIG. 2 shows a schematic flow diagram of a specific embodiment of a method for operating an energy storage device. In step S1, an energy consumption of a consumer 7 during a past time interval is determined. In step S2, there takes place a determination of an energy production quantity that was produced by power station 2 during the past time interval. In step S3, there takes place a determination of the quantity of energy currently stored in an energy storage device assigned to power station 2, said quantity being provided for an operation, in particular autarkic operation, of consumer 5. In step S4, an operating time in which consumer 5 can be operated by the quantity of energy produced by power station 2 and by the quantity of energy provided in energy storage device 7 for the operation, in particular autarkic operation, is determined.

In step S5 there takes place an adaptation of the minimum quantity of energy that is to be stored in energy storage device 7 and that is provided for the operation of consumer 5, taking into account the determined energy production quantity, the determined quantity of stored energy, and the determined energy consumption of the consumer, the adaptation taking place in such a way that consumer 5 is capable of being operated in autarkic fashion for the operating time. The adaptation takes place for example by charging or discharging the energy storage device, or through a modification of the quantity of minimum energy that is to be reserved in the energy storage device and is provided for the operation, for example autarkic operation, of the consumer.

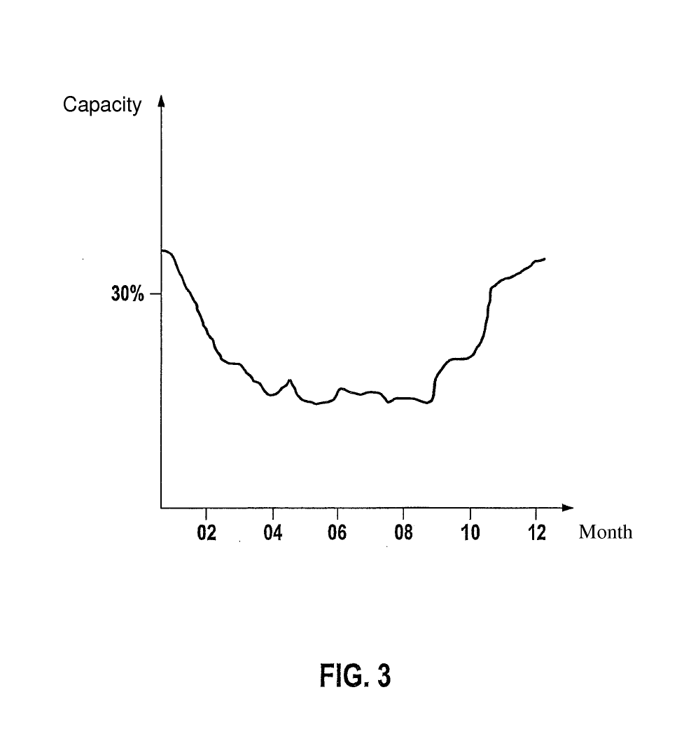

FIG. 3 is a schematic diagram showing the quantity of energy provided during one year for an operation of the consumer. On the vertical axis, the portion of the capacity of the energy storage device is shown that is reserved for an operation of the consumer. On the horizontal axis, the months of a year are shown. The diagram is to be understood only as an example, and is presented only in order to explain the functioning of the device and of the method.

During the winter months, for example January or February, the quantity of energy that is to be reserved for the operation of the consumer is increased. This comes about because, on the one hand, during the winter months the energy production quantity of the power station, in particular of a photovoltaic power station, is low, and on the other hand the energy consumption of the consumer is high. Therefore, the control device adapts the quantity of energy that is to be reserved in the energy storage device for the operation of the consumer to the conditions during winter.

During summer months, e.g. in July or August, the quantity of energy that is to be reserved for the operation of the consumer can be reduced, because the power station, for example a photovoltaic power station or a hydropower station, can produce more energy during the summer months, and the consumer uses a smaller quantity of energy during the summer months.

Through the reduction of the quantity of energy that is to be reserved, the storage capacity for increasing self-consumption is increased, while maintaining the selected autarkic time.

Although the present invention has been described above on the basis of exemplary embodiments, it is not limited thereto, but rather can be modified in various ways. In particular, the present invention can be altered or modified in many ways without departing from the core of the present invention.

What is claimed is:

1. A device for determining and/or controlling an operating time of a consumer, which is coupled to a power station and to an energy storage device, comprising;
a first determining device to determine an energy production quantity that was produced by the power station during a past time interval;
a second determining device to determine the energy consumption of the consumer during a past time interval;
a third determining device to determine the quantity of energy currently stored in the energy storage device and provided for an operation of the consumer; and
at least one of:
a prediction device to determine and display, taking into account the determined energy production quantity, the determined quantity of stored energy, and the determined energy consumption of the consumer, an operating time in which the consumer can be operated using the quantity of energy produced by the power station and using the quantity of energy currently stored in the energy storage device; and
a control device to determine an operating time of the consumer and to adapt, taking into account the determined energy production quantity, the determined quantity of stored energy, and the determined energy consumption of the consumer, the quantity of energy that is currently stored in the energy storage device and is provided for the operation of the consumer, the adaptation taking place so that the consumer can be operated for the determined operating time.

2. The device of claim 1, wherein the control device is configured to adapt, taking into account the weather and/or the season of the year, the currently stored quantity of energy provided for the operation of the consumer, so that the consumer can be operated for the operating time.

3. The device of claim 1, wherein the prediction device is configured to determine the operating time, taking into account the weather and/or the season of the year.

4. The device of claim 1, wherein the prediction device is configured to determine the operating time for various operating modes of the consumer, for maximum operation, partial operation, and minimum operation of the consumer.

5. The device of claim 1, wherein the control device is configured to adapt the quantity of energy stored in the energy storage device so that the consumer is operatable in various operating modes, including in maximum operation, partial operation, and in minimum operation.

6. The device of claim 1, wherein the device is configured as at least one of a central computing device and a decentralized computing device.

7. The device of claim 1, wherein the time interval amounts to minutes, hours, days, weeks, months, and/or years.

8. The device of claim 1, wherein the control device is configured to adapt the quantity of energy stored in the energy storage device so that the consumer can be operated in autarkic fashion for the operating time.

9. A method for operating an energy storage device coupled to a power station, the method comprising:
performing at least one of:
(i) determining an energy consumption of a consumer coupled to the energy storage device during a past time interval;
(ii) determining an energy production quantity that was produced by the power station during a past time interval;
(iii) determining the quantity of energy that is currently stored in the energy storage device and that is provided for an operation of the consumer;
(iv) determining and displaying of an operating time for the consumer, taking into account the determined energy production quantity, the determined quantity of stored energy, and the determined energy consumption of the consumer; and
(v) determining an operating time in which the consumer is operatable using the quantity of energy produced by the power station and the quantity of energy provided in the energy storage device for the operation; and
adapting the minimum quantity of energy to be reserved in the energy storage device and provided for the operation of the consumer, taking into account the determined energy production quantity, the determined quantity of stored energy, and the determined energy consumption of the consumer, the adaptation taking place so that the consumer is operatable for the operating time.

10. The method of claim 9, wherein the power station is a photovoltaic power station.
